(19) United States
(12) Patent Application Publication
(10) Pub. No.: US 2026/0226712 A1
(43) Pub. Date: Aug. 6, 2026

(54) SYSTEM INCLUDING WORK MACHINE, AND METHOD FOR ESTIMATING LOAD STATE OF WORK MACHINE

(71) Applicant: KOMATSU LTD., Tokyo (JP)

(72) Inventors: Yuki MATSUO, Minato-ku, Tokyo (JP); Yuki NAKATANI, Minato-ku, Tokyo (JP); Yuuki KASAOKA, Minato-ku, Tokyo (JP); Nobuyasu SUGIHARA, Minato-ku, Tokyo (JP)

(73) Assignee: KOMATSU LTD., Tokyo (JP)

(21) Appl. No.: 19/149,551

(22) PCT Filed: Dec. 8, 2023
(86) PCT No.: PCT/JP2023/044014

§ 371 Date: Jul. 20, 2025

(30) Foreign Application Priority Data
Feb. 20, 2023 (JP) 2023-024016

(51) Int. Cl. E02F 9/22; G01B 7/16

(52) U.S. Cl. CPC E02F 9/2221; G01B 7/18

(57) ABSTRACT

A work implement is attached to a work machine body. A plurality of strain sensors are arranged along a portion of the work implement that intersects with a virtual plane. A controller estimates a load state of the working implement based on strain data detected by the plurality of strain sensors.

### TECHNICAL FIELD

The disclosure relates to a system including a work machine and a method for estimating a load state of a work machine.

### BACKGROUND ART

In the related art, a life prediction system for a work implement is disclosed in, for example, JP2022-124929 A (Patent Document 1). In Patent Document 1, a strain of a life prediction target portion is calculated based on operation information detected by an operation detection device.

### CITATION LIST

### Patent Literature

Patent Document 1: JP 2022-124929 A

### SUMMARY OF INVENTION

### Technical Problem

In order to measure stresses at a large number of portions on a work implement during operation, a large number of strain gauges are required. However, attachment of a large number of strain gauges complicates wiring. In addition, monitoring strain for a long period of time needs a large-scale apparatus.

An object of the present disclosure is to provide a system including a work machine and a method for estimating a load state of a work machine that can determine deformation of an entire work implement with a simple device configuration.

### Solution to Problem

A system including a work machine of the present disclosure includes a work machine body, a work implement, a plurality of strain sensors, and a controller. The work implement is attached to the work machine body. The plurality of strain sensors are arranged along a portion of the work implement that intersects with a virtual plane. The controller estimates a load state of the work implement based on strain data detected by the plurality of strain sensors.

Another system including a work machine of the present disclosure includes a work machine body, a work implement, a plurality of strain sensors, and a controller. The work implement is attached to the work machine body. The plurality of strain sensors are arranged at at least four locations of the work implement. The controller estimates a load state of the work implement based on strain data of the at least four locations detected by the plurality of strain sensors.

Still another system including a work machine of the present disclosure includes a work machine body, a work implement, a plurality of strain sensors, a display device, and a controller. The work implement is attached to the work machine body. The plurality of strain sensors are arranged along a portion of the work implement that intersects with a virtual plane. The controller determines a load mode of the work implement based on strain data detected by the plurality of strain sensors, estimates a stress at any location of the work implement, and displays, on the display device, when the stress estimated is greater than a predetermined threshold value, a load mode and a portion of the work implement when the stress estimated is greater than the predetermined threshold value.

A method for estimating a load state of a work machine of the present disclosure is a method for estimating a load state of a work machine including a work machine body and a work implement attached to the work machine body and includes the following steps.

A plurality of strain sensors are arranged along a portion of the work implement that intersects with a virtual plane. A load state of the work implement is estimated based on strain data detected by the plurality of strain sensors.

Another method for estimating a load state of a work machine of the present disclosure is a method for estimating a load state of a work machine including a work machine body and a work implement attached to the work machine body and includes the following steps.

A plurality of strain sensors are arranged at at least four locations of the work implement. A load state of the work implement is estimated based on strain data of the at least four locations detected by the plurality of strain sensors.

Still another method for estimating a load state of a work machine of the present disclosure is a method for estimating a load state of a work machine including a work machine body, a work implement attached to the work machine body, and a display device and includes the following steps.

A plurality of strain sensors are arranged along a portion of the work implement that intersects with a virtual plane. A load mode of the work implement is determined based on strain data detected by the plurality of strain sensors. A stress at any location of the work implement is estimated. When the stress estimated is greater than a predetermined threshold value, a load mode and a portion of the work implement when the stress estimated is greater than the predetermined threshold value are displayed on the display device.

### Advantageous Effects of Invention

According to the present disclosure, it is possible to realize a system including a work machine and a method for estimating a load state of a work machine, both capable of determining deformation of an entire work implement with a simple device configuration.

### BRIEF DESCRIPTION OF DRAWINGS

FIG. 1 is a diagram illustrating a configuration of a hydraulic excavator as an example of a work machine in an embodiment of the present disclosure.

FIG. 2 is a perspective view illustrating a configuration of a boom as an example of a work implement of the hydraulic excavator illustrated in FIG. 1.

FIG. 3 is a cross-sectional view illustrating a state in which a strain sensor is arranged on a cross section of the boom that intersects with a virtual plane.

FIG. 4 is a diagram illustrating a configuration of the strain sensor illustrated in FIG. 1.

FIG. 5 is a diagram illustrating functional blocks of a controller illustrated in FIG. 1.

FIG. 6 is a flowchart illustrating a method for estimating a load state of a work machine in an embodiment of the present disclosure.

FIG. 7 is a diagram for explaining a load mode of the work implement and a stress acting on the work implement.

FIG. 8 is a flowchart for explaining a method for determining a load mode in FIG. 7.

FIG. 9 is a diagram for explaining a virtual plane that intersects with the work implement.

### DESCRIPTION OF EMBODIMENTS

Hereinafter, embodiments of the present disclosure will be described with reference to the drawings.

In the description and the drawings, the same components or corresponding components are denoted by the same reference numerals, and redundant description will not be repeated.

Additionally, in the drawings, the configuration may be omitted or simplified for convenience of description.

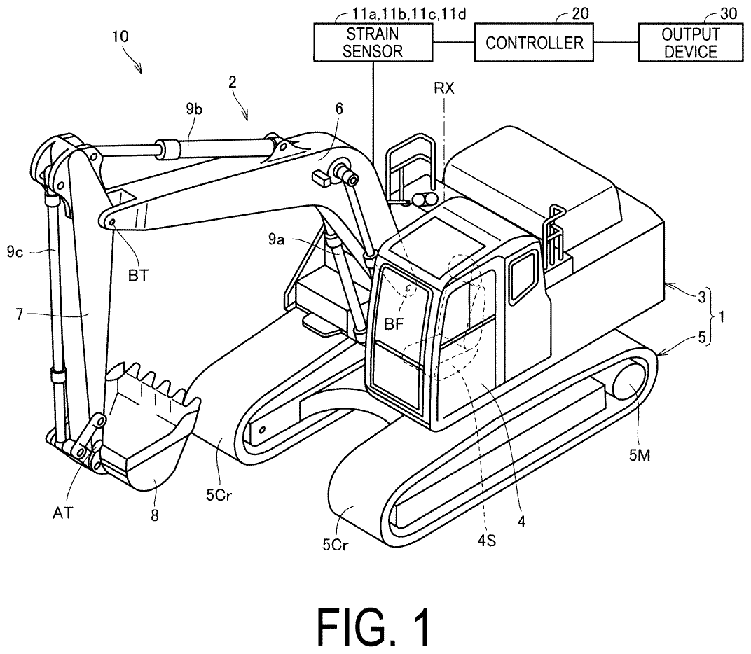

In the following description, “upper”, “lower”, “front”, “rear”, “left”, and “right” are directions based on an operator seated on an operator seat 4S in a cab 4 illustrated in FIG. 1.

### Configuration of Work Machine

A configuration of a hydraulic excavator as an example of a work machine will be described with reference to FIG. 1.

FIG. 1 is a diagram illustrating a configuration of a hydraulic excavator as an example of a work machine in an embodiment of the present disclosure. As illustrated in FIG. 1, the hydraulic excavator 10 includes a work machine body 1 and a work implement 2 that is actuated by hydraulic pressure. The work machine body 1 includes a revolving unit 3 and a travel unit 5.

The travel unit 5 includes a pair of crawler belts 5Cr and a travel motor 5M. The hydraulic excavator 10 can travel by rotation of the crawler belts 5Cr. The travel motor 5M is provided as a drive source of the travel unit 5.

The revolving unit 3 is arranged on the travel unit 5 and supported by the travel unit 5. The revolving unit 3 is revolvable with respect to the travel unit 5 about a revolving axis RX by a revolving motor (not illustrated). The revolving axis RX is a virtual straight line serving as a center of revolution of the revolving unit 3.

The revolving unit 3 is provided with a cab 4. The cab 4 is provided with an operator seat 4S on which an operator sits. An operator (occupant) who rides in the cab 4 can operate the work implement 2, perform a revolving operation of the revolving unit 3 with respect to the travel unit 5, and perform a traveling operation of the hydraulic excavator 10 by the travel unit 5.

The work implement 2 is attached to the work machine body 1. The work implement 2 is supported by the revolving unit 3. The work implement 2 includes a boom 6, an arm 7, and a bucket 8. The work implement 2 further includes a boom cylinder 9a, an arm cylinder 9b, and a bucket cylinder 9c.

The boom 6 is rotatably connected to the work machine body 1. Specifically, a base end portion of the boom 6 is rotatably connected to the revolving unit 3 with a boom foot pin BF as a fulcrum. The arm 7 is rotatably connected to the boom 6. Specifically, a base end portion of the arm 7 is rotatably connected to a tip end portion of the boom 6 with a boom top pin BT as a fulcrum. The bucket 8 is rotatably connected to the arm 7. Specifically, a base end portion of the bucket 8 is rotatably connected to a tip end portion of the arm 7 with an arm top pin AT as a fulcrum.

The boom 6 can be driven with respect to the work machine body 1 by the boom cylinder 9a. By this driving, the boom 6 can be rotated in the vertical direction with respect to the revolving unit 3 with the boom foot pin BF as a fulcrum.

The arm 7 can be driven with respect to the boom 6 by the arm cylinder 9b. By this driving, the arm 7 can be rotated in the vertical direction or in the front-rear direction with respect to the boom 6 with the boom top pin BT as a fulcrum.

The bucket 8 can be driven with respect to the arm 7 by the bucket cylinder 9c. By this driving, the bucket 8 can be rotated in the vertical direction with respect to the arm 7 with the arm top pin AT as a fulcrum.

### Load State Estimation System of Work Machine

Next, a load state estimation system of the work machine will be described with reference to FIGS. 1 to 5.

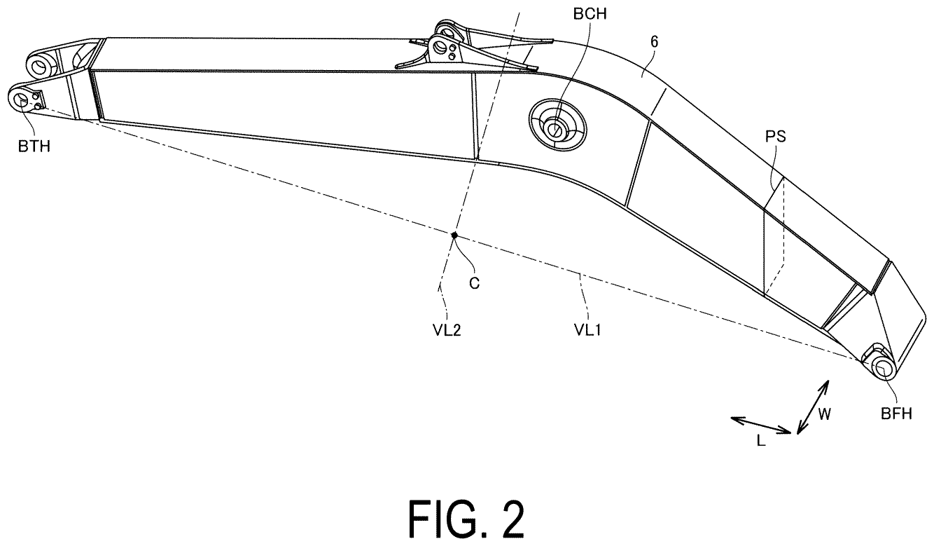

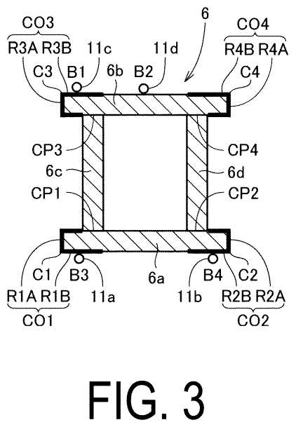

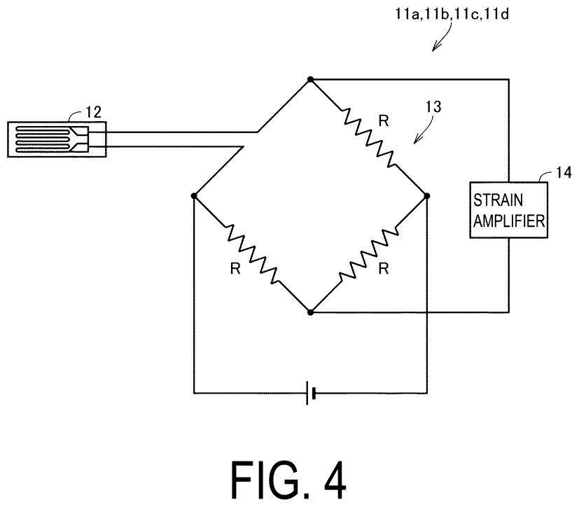

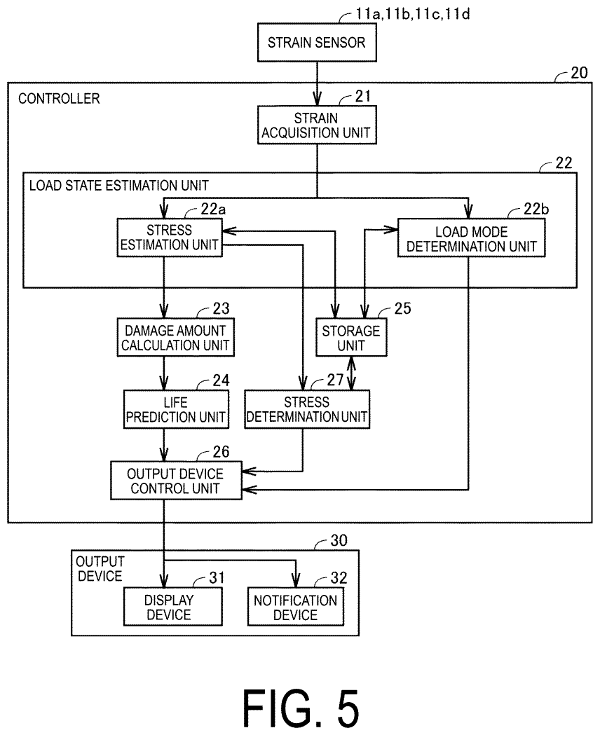

FIG. 2 is a perspective view illustrating a configuration of a boom as an example of a work implement of the hydraulic excavator illustrated in FIG. 1. FIG. 3 is a cross-sectional view illustrating a state in which a strain sensor is arranged on a cross section of the boom that intersects with a virtual plane. FIG. 4 is a diagram illustrating a configuration of the strain sensor illustrated in FIG. 1. FIG. 5 is a diagram illustrating functional blocks of a controller illustrated in FIG. 1.

As illustrated in FIG. 1, the load state estimation system of the work machine 10 in the present embodiment estimates, for example, a load state of the work implement 2 of the work machine 10. The work implement 2 for which a load state is estimated is, for example, the work implement 2 of the hydraulic excavator 10, and is the boom 6 or the arm 7. In addition, the load state of the work implement 2 includes a stress and a load mode of the work implement 2.

Note that the work implement 2 for which a load state is estimated may be a work implement of another work machine such as a wheel loader other than the hydraulic excavator 10. Below, the boom 6 will be described as an example of the work implement 2 for which a load state is estimated.

The load state estimation system of the work machine 10 according to the present embodiment includes a plurality of strain sensors 11a, 11b, 11c, and 11d, a controller 20, and an output device 30.

The plurality of strain sensors 11a, 11b, 11c, and 11d are, for example, four strain sensors. The plurality of strain sensors 11a, 11b, 11c, and 11d are attached to the work implement 2 for which a load state is to be estimated. The plurality of strain sensors 11a, 11b, 11c, and 11d are attached to the boom 6, for example. The plurality of strain sensors 11a, 11b, 11c, and 11d may be attached to the arm 7, for example.

As illustrated in FIG. 2, the plurality of strain sensors 11a, 11b, 11c, and 11d are arranged along a portion of the boom 6 that intersects with a virtual plane PS. The virtual plane PS is located closer to the work machine body 1 than a center of the boom 6 in a longitudinal direction L. The virtual plane PS passes through a center C of a virtual straight line VL1 connecting a boom foot pin hole BFH and a boom top pin hole BTH, and is located closer to the boom foot pin hole BFH than a virtual straight line VL2 orthogonal to the virtual straight line VL1 in a side view of the boom 6. In addition, the virtual plane PS is located closer to the boom foot pin hole BFH than a boom cylinder attachment hole BCH.

As illustrated in FIG. 3, the boom 6 has two lateral plates 6a and 6b and two vertical plates 6c and 6d. The two lateral plates 6a and 6b include a lower plate 6a and an upper plate 6b. The two vertical plates 6c and 6d include a left plate 6c and a right plate 6d. The two lateral plates 6a and 6b are arranged substantially parallel to each other. The two vertical plates 6c and 6d are arranged substantially parallel to each other. The two vertical plates 6c and 6d are sandwiched between the two lateral plates 6a and 6b, for example.

FIG. 3 illustrates a cross section of the boom 6 that intersects with the virtual plane PS. The boom 6 has a rectangular frame-like cross-sectional shape formed by the two lateral plates 6a and 6b and the two vertical plates 6c and 6d. The rectangular frame-like cross-sectional shape of the boom 6 has four corner portions CO1, CO2, CO3, and CO4.

The plurality of strain sensors 11a, 11b, 11c, and 11d are attached to an outer periphery side of the rectangular frame of the boom 6. The plurality of strain sensors 11a, 11b, 11c, and 11d may be attached to an inner periphery side of the rectangular frame. The strain sensors 11a and 11b are attached to, for example, the lower plate 6a. The strain sensors 11c and 11d are attached to, for example, the upper plate 6b. The strain sensors 11a, 11b, 11c, and 11d may be attached to the vertical plates 6c and 6d. Each of the plurality of strain sensors 11a, 11b, 11c, and 11d is fixed to the boom 6 by, for example, an adhesive.

The plurality of strain sensors 11a, 11b, 11c, and 11d are arranged at at least three corner portions CO1, CO2, and CO3 among the four corner portions CO1, CO2, CO3, and CO4 of the boom 6. The corner portion includes a region from a connection portion between the lateral plate and the vertical plate to the closest corner and a region from a facing region of the connection portion with the lateral plate or the vertical plate interposed therebetween to the closest corner.

Therefore, the corner portion CO1 includes a region RIA from a connection portion CP1 of the lower plate 6a and the left plate 6c to a corner C1, and a region RIB from a facing region of the connection portion CP1 to the corner C1. The corner portion CO2 includes a region R2A from a connection portion CP2 of the lower plate 6a and the right plate 6d to a corner C2, and a region R2B from a facing region of the connection portion CP2 to the corner C2. The corner portion CO3 includes a region R3A from a connection portion CP3 of the upper plate 6b and the left plate 6c to a corner C3, and a region R3B from a facing region of the connection portion CP3 to the corner C3. The corner portion CO4 includes a region R4A from a connection portion CP4 of the upper plate 6b and the right plate 6d to a corner C4, and a region R4B from a facing region of the connection portion CP4 to the corner C4. Note that in FIG. 4, the corner portions CO1, CO2, CO3, and CO4 are indicated by thick lines.

In the present embodiment, the strain sensor 11a is arranged at the corner portion CO1. The strain sensor 11b is arranged at the corner portion CO2. The strain sensor 11c is arranged at the corner portion CO3. The strain sensor 11d is arranged between the corner portion CO3 and the corner portion CO4. The strain sensor 11d is arranged, for example, at a widthwise central portion of the upper plate 6b.

The plurality of strain sensors 11a, 11b, 11c, and 11d are arranged on at least two surfaces different from each other. The strain sensors 11a and 11b are arranged on the outer periphery-side surface of the lower plate 6a, and the strain sensors 11c and 11d are arranged on the outer periphery-side surface of the upper plate 6b.

The strain sensors 11a and 11b may be arranged, for example, on the inner periphery-side surface of the lower plate 6a. The strain sensors 11c and 11d may be arranged, for example, on the inner periphery-side surface of the upper plate 6b.

As illustrated in FIG. 4, each of the strain sensors 11a, 11b, 11c, and 11d includes a strain gauge 12, a bridge circuit 13, and a strain amplifier 14. The strain gauge 12 is connected to the work implement 2 (for example, the boom 6) and expands and contracts together with the work implement 2. As the strain gauge 12 expands and contracts, a metal wire of the strain gauge 12 expands and contracts, and then as a cross-sectional area of the metal wire changes, an electrical resistance of the metal wire changes. The strain sensor detects strain by measuring changes in the electrical resistance of the metal wire.

The bridge circuit 13 is provided to accurately measure the electrical resistance of the metal wire of the strain gauge 12. The bridge circuit 13 converts a change in the electric resistance of the metal wire into a change in voltage. Since the voltage converted from the electric resistance by the bridge circuit 13 is small, the strain amplifier 14 is provided to amplify the voltage.

At least the strain gauge 12 and the bridge circuit 13 in each of the strain sensors 11a, 11b, 11c, and 11d are composed of a semiconductor device. The strain gauge 12 and the bridge circuit 13 may be composed of a single semiconductor device including both the strain gauge 12 and the bridge circuit 13 or may be composed of a semiconductor device separate from each other. The strain amplifier 14 may also be composed of a semiconductor device. Additionally, the strain amplifier 14 may be provided in the same semiconductor device together with the strain gauge 12 and the bridge circuit 13, or may be provided in a semiconductor device separate from the strain gauge 12 and the bridge circuit 13.

As illustrated in FIG. 5, the controller 20 estimates a load state of the work implement 2 based on strain data detected by the plurality of strain sensors 11a, 11b, 11c, and 11d. The controller 20 estimates the load state of the work implement 2 based on the strain data of at least four locations of the boom 6.

The controller 20 estimates stress at nay location of the work implement 2 based on the strain data detected by the plurality of strain sensors 11a, 11b, 11c, and 11d.

The controller 20 calculates a damage amount of the work implement 2 based on the strain data detected by the plurality of strain sensors 11a, 11b, 11c, and 11d. The controller 20 displays a life of the work implement 2 predicted from a cumulative value of the damage amount on a display device 31.

When the estimated stress is greater than a predetermined threshold value, the controller 20 outputs an alarm signal to a notification device 32.

The controller 20 includes a processor, a main memory, and a storage. The processor is a central processing unit (CPU) or the like. The main memory includes, for example, a nonvolatile memory such as a read only memory (ROM) and a volatile memory such as a random access memory (RAM). The controller 20 reads out a program stored in the storage, loads the program into the main memory, and executes predetermined processing in accordance with the program.

Each of the controller 20 and the output device 30 may be mounted on the hydraulic excavator 10, or may be arranged outside and away from the hydraulic excavator 10. When each of the controller 20 and the output device 30 is arranged outside and away from the hydraulic excavator 10, each of the controller 20 and the output device 30 may be wirelessly connected to the strain sensors 11a, 11b, 11c, and 11d, and the like. The controller 20 may be stored in a server remote from the hydraulic excavator 10. In addition, the output device 30 is arranged away from the hydraulic excavator 10, so a manager can check the display device 31 at a remote place away from the hydraulic excavator 10 and recognize notification information provided by the notification device 32. When the output device 30 is mounted on the hydraulic excavator 10, a user who rides on the hydraulic excavator 10 can check the display device 31 mounted on the hydraulic excavator 10 and recognize notification information provided by the notification device 32. At least one of the controller 20 and the output device 30 may be mounted on a portable information terminal such as a smartphone, a tablet, or a personal computer.

The controller 20 includes a strain acquisition unit 21, a load state estimation unit 22, a damage amount calculation unit 23, a life prediction unit 24, a storage unit 25, an output device control unit 26, and a stress determination unit 27. The strain acquisition unit 21 acquires strain data detected by the strain sensors 11a, 11b, 11c, and 11d. The strain acquisition unit 21 outputs the acquired strain data to the load state estimation unit 22.

The load state estimation unit 22 includes a stress estimation unit 22a and a load mode determination unit 22b. The stress estimation unit 22a estimates stress at any location of the work implement 2 based on the acquired strain data. When estimating the stress, the stress estimation unit 22a refers to data stored in the storage unit 25 and indicating a stress distribution at each location of the work implement 2. The stress estimation unit 22a can estimate a stress distribution of the entire work implement 2 based on the strain data detected by the strain sensors 11a, 11b, 11c, and 11d by referring to the data indicating the stress distributions. The stress estimation unit 22a can also estimate a stress value of a critical portion of the work implement 2. The critical portion of the work implement 2 is a portion of the work implement 2 where a crack is most likely to occur, and usually corresponds to a welded portion. The stress estimation unit 22a outputs a signal indicating the estimated stress to the damage amount calculation unit 23 and the stress determination unit 27.

The load mode determination unit 22b determines a load mode of the work implement 2 based on the acquired strain data. The load mode determination unit 22b refers to a predetermined value stored in the storage unit 25 when determining the load mode. The load mode determination unit 22b outputs a signal indicating the determined load mode to the output device control unit 26.

The damage amount calculation unit 23 calculates a damage amount of the work implement based on the acquired signal indicating the stress. The damage amount is calculated from the stress value using a rainflow method. The damage amount calculation unit 23 outputs a signal indicating the calculated damage amount to the life prediction unit 24.

The life prediction unit 24 predicts a life of the work implement 2 based on the acquired damage amount. The life prediction unit 24 predicts the life of the work implement 2 from a cumulative value of the damage amount. The life prediction unit 24 outputs a signal indicating the predicted life to the output device control unit 26.

The stress determination unit 27 determines whether the acquired stress is greater than a predetermined threshold value. When making this determination, the stress determination unit 27 refers to a predetermined threshold value stored in the storage unit 25. The stress determination unit 27 outputs a signal indicating the determination result to the output device control unit 26.

The output device control unit 26 controls the output device 30 by outputting a control command to the output device 30 based on the acquired signal. The output device control unit 26 controls the output device 30 to display the life acquired from the life prediction unit 24 on the display device 31. When acquiring, from the stress determination unit 27, a determination result that the stress estimated by the stress estimation unit 22a is greater than the predetermined threshold value, the output device control unit 26 outputs an alarm signal to the output device 30. The notification device 32 of the output device 30 issues an alarm based on the alarm signal.

When acquiring, from the stress determination unit 27, a determination result that the stress estimated by the stress estimation unit 22a is greater than the predetermined threshold value, the output device control unit 26 controls the display device 31 to display a load mode when the estimated stress is greater than the predetermined value and a portion of the work implement 2 when the estimated stress is greater than the predetermined value.

### Method for Estimating Load State of Work Machine

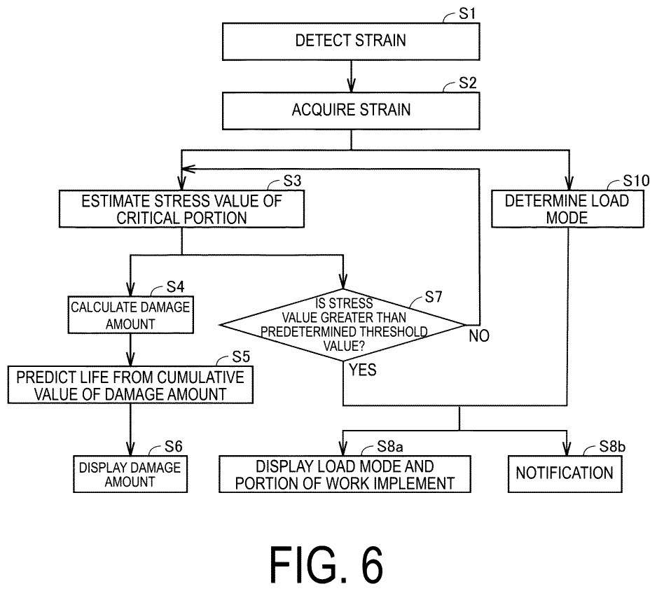

Next, a method for estimating a load state of a work machine according to the present embodiment will be described with reference to FIGS. 5 and 6.

FIG. 6 is a flowchart illustrating a method for estimating a load state of a work machine in an embodiment of the present disclosure. As illustrated in FIGS. 5 and 6, in the present embodiment, strain of the work implement 2 (for example, the boom 6) is detected by the plurality of strain sensors 11a, 11b, 11c, and 11d (step S1: FIG. 6). The strain acquisition unit 21 of the controller 20 acquires strain data of the boom 6 detected by the plurality of strain sensors 11a, 11b, 11c, and 11d (step S2: FIG. 6).

The load state estimation unit 22 of the controller 20 estimates a load state of the boom 6 based on the acquired strain data. The load state of the work implement 2 includes a stress of the work implement 2 and a load mode of the work implement 2. The stress of the work implement 2 is estimated by the stress estimation unit 22a of the controller 20 (step S3: FIG. 6), and the load mode of the work implement 2 is determined by the load mode determination unit 22b of the controller 20 (step S10: FIG. 6).

The stress estimation unit 22a of the controller 20 estimates a stress at any location of the work implement 2 based on the acquired strain data. When estimating the stress, the stress estimation unit 22a refers to data stored in the storage unit 25 and indicating a stress distribution at each location of the work implement 2. With this, a stress value of the critical portion of the work implement 2 is estimated (step S3: FIG. 6). The stress estimation unit 22a outputs a signal indicating the estimated stress to the damage amount calculation unit 23 and the stress determination unit 27.

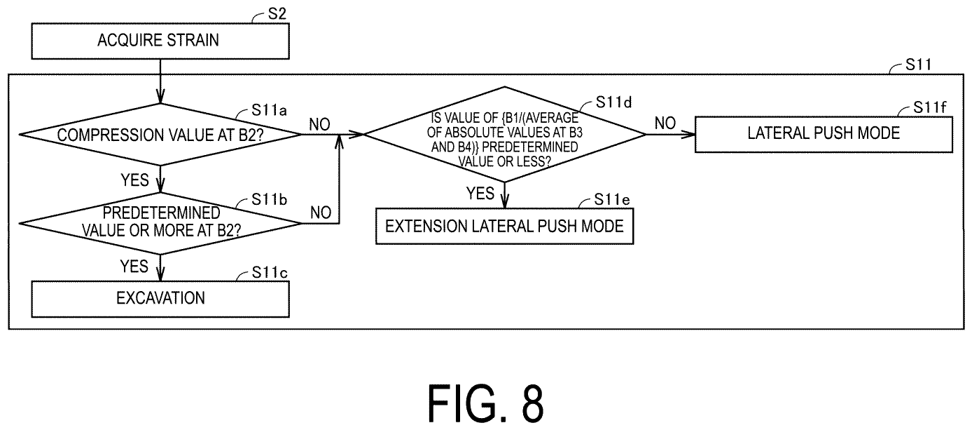

The load mode determination unit 22b of the controller 20 determines the load mode of the work implement 2 based on the strain data acquired from the strain acquisition unit 21 (step S10: FIG. 6). The load mode determination unit 22b determines the load mode in accordance with a flow of FIG. 8 described below. The load mode determination unit 22b refers to a predetermined value stored in the storage unit 25 at the time of the determination. The load mode determination unit 22b outputs a signal indicating the determined load mode to the output device control unit 26.

The damage amount calculation unit 23 of the controller 20 calculates a damage amount of the work implement 2 based on a signal indicating the acquired stress (step S4: FIG. 6). The damage amount is calculated from the stress value using a rainflow method. The damage amount calculation unit 23 outputs a signal indicating the calculated damage amount to the life prediction unit 24.

The life prediction unit 24 of the controller 20 predicts a life of the work implement 2 based on the acquired damage amount. The life prediction unit 24 predicts the life of the work implement 2 from a cumulative value of the damage amount (step S5: FIG. 6). The life prediction unit 24 outputs a signal indicating the predicted life to the output device control unit 26.

The output device control unit 26 displays the life on the display device 31 based on the acquired signal indicating the life (step S6: FIG. 6).

The stress determination unit 27 of the controller 20 determines whether the stress value acquired from the stress estimation unit 22a is greater than a predetermined threshold value (step S7: FIG. 6). When making this determination, the stress determination unit 27 refers to a predetermined threshold value stored in the storage unit 25. When the stress determination unit 27 determines that the stress value is equal to or less than the predetermined threshold value, the estimation of the stress value (step S3) and the determination of the stress value (step S7) are repeated.

In addition, when the stress determination unit 27 determines that the stress value is greater than the predetermined threshold value, the load mode acting on the work implement 2 and the portion of the work implement 2 where the stress value becomes greater than the predetermined threshold value are displayed on the display device 31 (step S8a). In addition, when the stress determination unit 27 determines that the stress value is greater than the predetermined threshold value, the notification device 32 issues an alarm (alert) (step S8b).

### Method for Determining Load Mode

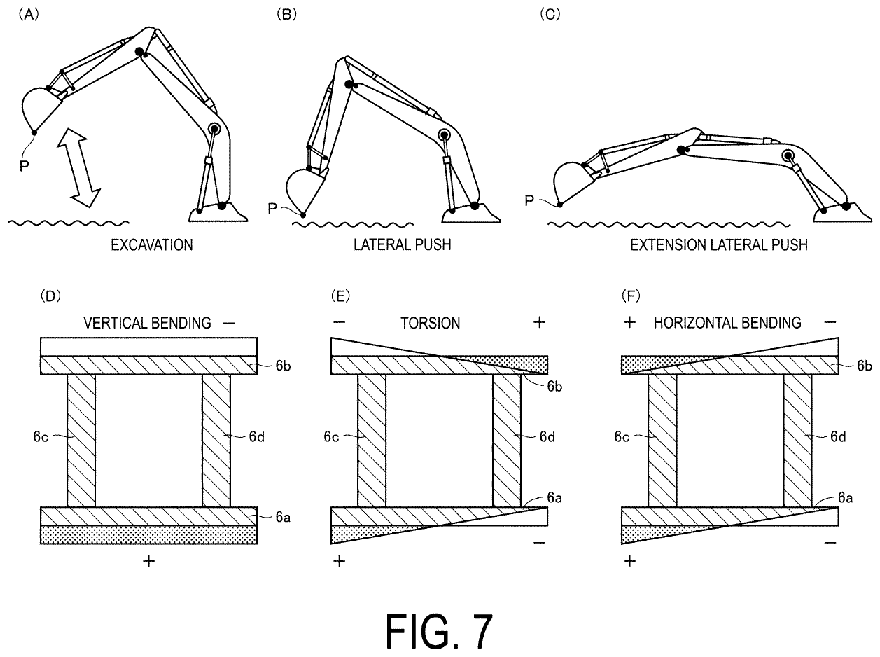

Next, a method for determining a load mode in the present embodiment will be described with reference to FIGS. 7 and 8.

FIG. 7 is a diagram for explaining a load mode of the work implement and a stress acting on the work implement. FIG. 8 is a flowchart for explaining a method for determining a load mode in FIG. 6.

In an excavation mode ((A) of FIG. 7) among load modes, an operation of lowering the boom 6 or the arm 7 is assumed. In a lateral push mode ((B) of FIG. 7) among the load modes, an operation in which a side surface of the bucket 8 is in contact with an object while the revolving unit 3 revolves rightward or leftward is assumed. In an extension lateral push mode ((C) of FIG. 7) among the load modes, an operation in which the arm 7 is extended forward while the boom 6 is lowered, and a side surface of the bucket 8 is in contact with an object while the revolving unit 3 revolves rightward or leftward is assumed.

In (D), (E), and (F) of FIG. 7, the symbol “− (minus)” means a compressive stress, and the symbol “+ (plus)” means a tensile stress. In (D), (E), and (F) of FIG. 7, a white-out region indicates a magnitude of the compressive stress acting on the work implement 2, and a dot-hatched region indicates a magnitude of the tensile stress acting on the work implement 2.

The present inventors have intensively studied a method for estimating the stress of the entire work implement 2 with a small number of strain sensors. The present inventors have noted that when bending or torsion acts on the work implement 2, different characteristics appear in the cross section of the work implement 2 depending on the load mode. Examples of the load mode include an excavation mode, an extension lateral push mode, and a lateral push mode. However, the load mode is not limited thereto and may include a high surface beating mode, a rolling mode, and the like.

First, when vertical bending acts on the work implement 2, as illustrated in (D) of FIG. 7, high stresses of the same sign act on both the corner portion and the plate center, and stresses of opposite signs occur in the upper and lower plates 6a and 6b, in the cross section of the work implement 2 that intersects with the virtual plane. In this case, for example, a high tensile stress acts on the lower surface (outer peripheral surface) of the lower plate 6a over the entire width, and a high compressive stress acts on the upper surface (outer peripheral surface) of the upper plate 6b over the entire width. When the vertical bending acts, for example, a high compressive stress may act on the lower surface of the lower plate 6a over the entire width, and a high tensile stress may act on the upper surface of the upper plate 6b over the entire width.

In addition, when torsion acts on the work implement 2, as illustrated in (E) of FIG. 7, stresses of opposite signs act on the left and right sides of the upper and lower plates 6a and 6b, and stresses of the same sign act on the diagonal portions of the upper and lower plates, in the cross section of the work implement 2 that intersects with the virtual plane. In this case, for example, stresses that transition from the tensile stress to the compressive stress act on the lower surface of the lower plate 6a from the left end toward the right end, and stresses that transition from the compressive stress to the tensile stress act on the upper surface of the upper plate 6b from the left end toward the right end. When torsion acts, for example, stresses that transition from the compressive stress to the tensile stress may act on the lower surface of the lower plate 6a from the left end toward the right end, and stresses that transition from the tensile stress to the compressive stress may act on the upper surface of the upper plate 6b from the left end toward the right end.

In addition, when horizontal bending acts on work implement 2, as illustrated in (F) of FIG. 7, stresses of opposite signs act on the left and right sides of the upper and lower plates, and stresses of opposite signs act on the diagonal portions of the upper and lower plates, in the cross section of work implement 2 that intersects with the virtual plane. In this case, for example, stresses that transition from the tensile stress to the compressive stress act on the lower surface of the lower plate 6a and the upper surface of the upper plate 6b from the left end toward the right end, respectively. When the horizontal bending facts, for example, stresses that transition from the compressive stress to the tensile stress may act on the lower surface of the lower plate 6a and the upper surface of the upper plate 6b from the left end toward the right end, respectively.

In the excavation mode, as illustrated in (A) of FIG. 7, a load in the vertical direction strongly acts on a load point P. As a result, in the excavation mode, as illustrated in (D) of FIG. 7, the influence of vertical bending becomes stronger in the upper and lower plates 6a and 6b, high stresses of the same sign act on both the corner portions and the central portions of the upper and lower plates 6a and 6b in the cross section of the work implement 2, and stresses of opposite signs occur in the upper and lower plates 6a and 6b.

In addition, in the lateral push mode, as illustrated in (B) of FIG. 7, since a load in the horizontal direction acts on the load point P, torsion acts on the left and right sides of the upper and lower plates. Thus, in the lateral push mode, as illustrated in (E) of FIG. 7, stresses of opposite signs act on the left and right sides of each of the upper and lower plates 6a and 6b, and stresses of the same sign act on the diagonal portions of the upper and lower plates 6a and 6b.

In addition, in the extension lateral push mode, as illustrated in (B) of FIG. 7, since a load in the horizontal direction acts on the load point P in a state where the work implement 2 is fully extended, horizontal bending and torsion act on the left and right sides of the upper and lower plates. Thus, in the extension lateral push mode, as illustrated in (E) of FIG. 7, stresses of opposite signs act on the left and right sides of each of the upper and lower plates 6a and 6b, and stresses of the same sign act on the diagonal portions of the upper and lower plates 6a and 6b. In addition, in the extension lateral push mode of the work implement 2, stresses on the upper surface of the upper plate 6b are lower than those in the lateral push mode due to the influence of horizontal bending.

From the above, in the cross section of the work implement 2 that intersects with the virtual plane PS, when the stress acting on a point B2 illustrated in FIG. 3 is a compressive stress and also a high stress (having a large absolute value), it can be determined that the load mode is the excavation mode.

In addition, in the cross section of the work implement 2 that intersects with the virtual plane PS, when the stress acting on the point B2 (see FIG. 3) is not a compressive stress or a high stress, it can be determined that the load mode is the lateral push mode or the extension lateral push mode.

Further, in the cross section of the work implement 2 that intersects with the virtual plane PS, when a value obtained by dividing a stress value at a point B1 by an average of absolute values of the stress values at points B3 and the point B4 is equal to or less than a predetermined value, it can be determined that the load mode is the extension lateral push mode.

Further, in the cross section of the work implement 2 that intersects with the virtual plane PS, when the value obtained by dividing the stress value at the point B1 by the average of the absolute values of the stress values at the point B3 and the point B4 is larger than the predetermined value, it can be determined that the load mode is the lateral push mode.

From the above, the load mode can be determined by the flow illustrated in FIG. 8. As illustrated in FIG. 8, the load mode determination unit 22b determines whether the stress value at the point B2 is a compression value (step S11a). When the stress value at the point B2 is the compression value, the load mode determination unit 22b determines whether the stress value at the point B2 is equal to or larger than a predetermined value (step S11b). When the stress value at the point B2 is equal to or larger than the predetermined value, the load mode determination unit 22b determines that the load mode is the excavation mode (step S11c).

On the other hand, when the stress value at the point B2 is not the compression value or when the stress value at the point B2 is less than the predetermined value, the load mode determination unit 22b determines whether the value obtained by dividing the stress value at the point B1 by the average of the absolute values of the stress values at the point B3 and the point B4 is equal to or less than a predetermined value (step S11d). When the value obtained by dividing the stress value at the point B1 by the average of the absolute values of the stress values at the point B3 and the point B4 is equal to or less than the predetermined value, the load mode determination unit 22b determines that the load mode is the extension lateral push mode (step S11e). In addition, when the value obtained by dividing the stress value at the point B1 by the average of the absolute values of the stress values at the point B3 and the point B4 is larger than the predetermined value, the load mode determination unit 22b determines that the load mode is the lateral push mode (step S11f).

### Effects

Next, the effects of the present embodiment will be described.

In the present embodiment, as illustrated in FIG. 5, the controller 20 estimates the load state of the work implement 2 based on the strain data detected by the plurality of strain sensors 11a, 11b, 11c, and 11d. As a result, the user or the manager can recognize the load state of the work implement 2 with a small number of strain sensors 11a, 11b, 11c, and 11d. Therefore, the user or the manager can perceive the load state of the entire work implement 2 with a simple device configuration. A used vehicle appraisal value of the hydraulic excavator 10 can also be calculated in accordance with the estimated load state. Accordingly, it is also possible to perform an appropriate used vehicle appraisal, such as reducing the appraisal value of the hydraulic excavator 10 that has frequently subjected to heavy loads. It is also possible to automatically transmit information on a service program such as inspection of the work implement 2 itself and supply of grease to each shaft of the work implement 2 to the user or manager in accordance with the estimated load state. Further, the obtained data can be utilized by a service technician to reduce downtime by providing recommendations to the operator, such as operation guidance and crack inspections, in order to avoid operations that apply loads exceeding the limit to the work implement 2.

In the present embodiment, as illustrated in FIG. 5, the controller 20 estimates the load state of the work implement 2 based on the strain data of at least four locations detected by the plurality of strain sensors 11a, 11b, 11c, and 11d. Thus, the load mode of the work implement 2 can be estimated, and the stress acting on the work implement 2 can be estimated. Therefore, the deformation of the entire work implement 2 can be perceived with a simple device configuration. A used vehicle appraisal value of the hydraulic excavator 10 can also be calculated in accordance with the estimated load state. Accordingly, it is also possible to reduce the appraisal value of the hydraulic excavator 10 that has frequently subjected to heavy loads. It is also possible to automatically transmit information on a service program such as inspection of the work implement 2 itself and supply of grease to each shaft of the work implement 2 to the user or manager in accordance with the estimated load state. Further, the obtained data can be utilized by a service technician to reduce downtime by providing recommendations such as operation guidance and crack inspections.

In the present embodiment, as illustrated in FIG. 5, the load mode includes at least excavation. Thus, the user or the manager can recognize the load mode acting on the work implement 2.

In the present embodiment, as illustrated in FIG. 5, the load mode includes at least lateral push and extension lateral push. Thus, the user or the manager can recognize the load mode acting on the work implement 2.

In the present embodiment, as illustrated in FIG. 5, the controller 20 estimates the load state at any location of the work implement 2 based on the strain data detected by the plurality of strain sensors 11a, 11b, 11c, and 11d. As a result, the user or the manager can recognize the entire stress of the work implement 2 with a small number of strain sensors 11a, 11b, 11c, and 11d. The user or manager can also recognize the stress acting on the critical portion of the work implement 2. The stress at the critical portion can also be presented and used for setting a target design life or usage conditions according to each destination region.

In the present embodiment, as illustrated in FIG. 3, the plurality of strain sensors 11a, 11b, 11c are arranged at at least three corner portions CO1, CO2, and CO3 of the work implement 2. Thus, the load mode can be determined.

In the present embodiment, as illustrated in FIG. 3, the plurality of strain sensors 11a, 11b, 11c, and 11d are arranged on at least two surfaces different from each other. Thus, the load mode can be determined.

In the present embodiment, as illustrated in FIG. 2, the virtual plane PS is located closer to the work machine body 1 than the center (virtual straight line VL2) of the work implement 2 in the longitudinal direction L. This causes, even when the plurality of strain sensors 11a, 11b, 11c, and 11d are arranged along the virtual plane PS1, a wiring path to be shortened and allows disconnection of wiring to be reduced. Damage and failure of the plurality of strain sensors 11a, 11b, 11c, and 11d during work are also reduced.

In the present embodiment, as illustrated in FIG. 5, the controller 20 calculates the damage amount to the work implement 2 based on the strain data detected by the plurality of strain sensors 11a, 11b, 11c, and 11d and displays the life of the work implement 2 predicted from the cumulative value of the damage amount on the display device 31. Thus, the user or the manager can easily check the life of the work implement 2.

In the present embodiment, as illustrated in FIG. 5, the controller 20 outputs an alarm signal when the estimated stress is greater than a predetermined threshold value. Accordingly, the user or the manager can easily recognize that the stress greater than the threshold value has been applied to the work implement 2. The user or the manager can also recognize, via an alarm, that there is a possibility that the hydraulic excavator 10 has been subjected to abnormal use or dangerous operation. When abnormal use or dangerous operation has been performed, an alarm can be issued in real time based on stress.

In the present embodiment, as illustrated in FIG. 5, the controller 20 determines the load mode of the hydraulic excavator 10 based on the strain data and estimates the stress at any location of the work implement 2 (for example, the boom 6). The controller 20 displays, on the display device 31, when the estimated stress is greater than the predetermined threshold value, the load mode and the portion of the work implement 2 when the estimated stress is greater than the predetermined threshold value. Accordingly, the user or the manager can easily check the load mode and the portion to which the stress greater than the threshold value has been applied. Therefore, the deformation of the entire work implement can be perceived with a simple device configuration. A used vehicle appraisal value of the hydraulic excavator 10 can also be calculated in accordance with the estimated load state. Accordingly, it is also possible to reduce the appraisal value of the hydraulic excavator 10 that has frequently subjected to heavy loads. It is also possible to automatically transmit information on a service program such as inspection of the work implement 2 itself and supply of grease to each shaft of the work implement 2 to the user or manager in accordance with the estimated load state. Further, the obtained data can be utilized by a service technician to reduce downtime by providing recommendations such as operation guidance and crack inspections.

In the present embodiment, as illustrated in FIG. 4, each of the plurality of strain sensors 11a, 11b, 11c, and 11d includes the strain gauge 12 and the bridge circuit 13, and the strain gauge 12 and the bridge circuit 13 are composed of a semiconductor device. This makes it possible to reduce the size of the strain gauge.

### Others

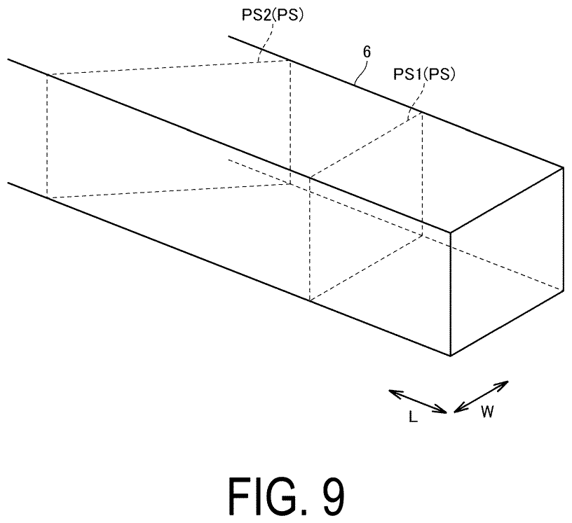

As illustrated in FIG. 9, the virtual plane PS that intersects with the work implement 2 may be a plane PS1 parallel to a short-side direction W of the work implement 2, or may be a plane PS2 not parallel to the short-side direction W of the work implement 2.

### Supplementary Notes

The above description includes the following additional features.

### Supplementary Note 1

A system including a work machine, the system including:

a work machine body;

a work implement attached to the work machine body;

a plurality of strain sensors arranged along a portion of the work implement that intersects with a virtual plane; and

a controller configured to estimate a load state of the work implement based on strain data detected by the plurality of strain sensors.

### Supplementary Note 2

A system including a work machine, the system including:

a work machine body;

a work implement attached to the work machine body;

a plurality of strain sensors arranged at at least four locations of the work implement; and

a controller configured to estimate a load state of the work implement based on strain data of the at least four locations detected by the plurality of strain sensors.

### Supplementary Note 3

The system including a work machine according to Supplementary Note 1 or 2, wherein

the work implement is a boom or an arm,

the load state of the work implement includes a load mode of the work implement, and

the load mode includes at least excavation.

### Supplementary Note 4

The system including a work machine according to any one of Supplementary Notes 1 to 3, wherein

the work machine includes a revolving unit,

the load state of the work implement includes a load mode of the work implement, and

the load mode includes at least a lateral push and an extension lateral push.

### Supplementary Note 5

The system including a work machine according to any one of Supplementary Notes 1 to 4, wherein

the work implement is a boom or an arm,

the load state of the work implement includes a stress of the work implement, and

the controller estimates a stress at any location of the work implement based on strain data detected by the plurality of strain sensors.

### Supplementary Note 6

The system including a work machine according to any one of Supplementary Notes 1 to 5, wherein

the work implement is a boom or an arm, and

the plurality of strain sensors are arranged at at least three corner portions of the work implement.

### Supplementary Note 7

The system including a work machine according to any one of Supplementary Notes 1 to 6, wherein

the Work implement is a boom or an arm, and

the plurality of strain sensors are arranged on at least two surfaces different from each other.

### Supplementary Note 8

The system including a work machine according to any one of Supplementary Notes 1 to 7, wherein

the work implement is a boom or an arm, and

the virtual plane is located closer to the work machine body than a center of the work implement in a longitudinal direction.

### Supplementary Note 9

The system including a work machine according to any one of Supplementary Notes 1 to 8, further including a display device, wherein

the controller calculates a damage amount of the work implement based on the strain

data detected by the plurality of strain sensors and displays, on the display device, a life of the work implement predicted from a cumulative value of the damage amount.

### Supplementary Note 10

The system including a work machine according to Supplementary Note 5, wherein the controller outputs an alarm signal when the stress estimated is greater than a predetermined threshold value.

### Supplementary Note 11

A system including a work machine, the system including:

a work machine body;

a work implement attached to the work machine body;

a plurality of strain sensors arranged along a portion of the work implement that intersects with a virtual plane;

a display device; and

a controller configured to determine a load mode of the work implement based on strain data detected by the plurality of strain sensors, estimate a stress at any location of the work implement, and display, on the display device, when the stress estimated is greater than a predetermined threshold value, a load mode and a portion of the work implement when the stress estimated is greater than the predetermined threshold value.

### Supplementary Note 12

The system including a work machine according to any one of Supplementary Notes 1 to 11, wherein

each of the plurality of strain sensors includes a strain gauge and a bridge circuit, and

the strain gauge and the bridge circuit are composed of a semiconductor device.

### Supplementary Note 13

A method for estimating a load state of a work machine including a work machine body and a work implement attached to the work machine body, the method including:

arranging a plurality of strain sensors along a portion of the work implement that intersects with a virtual plane; and

estimating a load state of the work implement based on strain data detected by the plurality of strain sensors.

### Supplementary Note 14

A method for estimating a load state of a work machine including a work machine body and a work implement attached to the work machine body, the method including:

arranging a plurality of strain sensors at at least four locations of the work implement; and

estimating a load state of the work implement based on strain data of the at least four locations detected by the plurality of strain sensors.

### Supplementary Note 15

A method for estimating a load state of a work machine including a work machine body, a work implement attached to the work machine body, and a display device, the method including:

arranging a plurality of strain sensors along a portion of the work implement that intersects with a virtual plane;

determining a load mode of the work implement based on strain data detected by the plurality of strain sensors;

estimating a stress at any location of the work implement; and

displaying, on the display device, when the stress estimated is greater than a predetermined threshold value, a load mode and a portion of the work implement when the stress estimated is greater than the predetermined threshold value.

It should be understood that the embodiments disclosed herein are illustrative in all respects and are not restrictive. The scope of the present invention is defined by the claims, not by the above description, and is intended to include all modifications within the meaning and scope equivalent to the claims.

### REFERENCE SIGNS LIST

1: Work machine body, 2: Work implement, 3: Revolving unit, 4: Cab, 4S: Operator seat, 5: Travel unit, 5Cr: Crawler belt, 5M: Travel motor, 6: Boom, 6a, 6b: Lateral plate, 6c, 6d: Vertical plate, 7: Arm, 8: Bucket, 9a: Boom cylinder, 9b: Arm cylinder, 9c: Bucket cylinder, 10: Hydraulic excavator, 11a, 11b, 11c, 11d: Strain sensor, 12: Strain gauge, 13: Bridge circuit, 14: Strain amplifier, 20: Controller, 21: Strain acquisition unit, 22: Load state estimation unit, 22a: Stress estimation unit, 22b: Load mode determination unit, 23: Damage amount calculation unit, 24: Life prediction unit, 25: Storage unit, 26: Output device control unit, 27: Stress determination unit, 30: Output device, 31: Display device, 32: Notification device, AT: Arm top pin, BCH: Boom cylinder attachment hole, BF: Boom foot pin, BFH: Boom foot pin hole, BT: Boom top pin, BTH: Boom top pin hole, C: Center, C1, C2, C3, C4: Corner, CO1, CO2, CO3, CO4: Corner portion, CP1, CP2, CP3, CP4: Connection portion.

1. A system comprising a work machine, the system comprising:
a work machine body;
a work implement attached to the work machine body;
a plurality of strain sensors arranged along a portion of the work implement that intersects with a virtual plane; and
a controller configured to estimate a load state of the work implement based on strain data detected by the plurality of strain sensors.

2. A system comprising a work machine, the system comprising:
a work machine body;
a work implement attached to the work machine body;
a plurality of strain sensors arranged at at least four locations of the work implement; and
a controller configured to estimate a load state of the work implement based on strain data of the at least four locations detected by the plurality of strain sensors.

3. The system comprising a work machine according to claim 1, wherein
the work implement is a boom or an arm,
the load state of the work implement includes a load mode of the work implement, and
the load mode includes at least excavation.

4. The system comprising a work machine according to claim 1, wherein
the work machine comprises a revolving unit,
the load state of the work implement includes a load mode of the work implement, and
the load mode includes at least a lateral push and an extension lateral push.

5. The system comprising a work machine according to claim 1, wherein
the work implement is a boom or an arm,
the load state of the work implement includes a stress of the work implement, and
the controller estimates a stress at any location of the work implement based on strain data detected by the plurality of strain sensors.

6. The system comprising a work machine according to claim 1, wherein
the work implement is a boom or an arm, and
the plurality of strain sensors are arranged at at least three corner portions of the work implement.

7. The system comprising a work machine according to claim 2, wherein
the work implement is a boom or an arm, and
the plurality of strain sensors are arranged on at least two surfaces different from each other.

8. The system comprising a work machine according to claim 1, wherein
the work implement is a boom or an arm, and
the virtual plane is located closer to the work machine body than a center of the work implement in a longitudinal direction.

9. The system comprising a work machine according to claim 1, further comprising a display device, wherein
the controller calculates a damage amount of the work implement based on the strain data detected by the plurality of strain sensors and displays, on the display device, a life of the work implement predicted from a cumulative value of the damage amount.

10. The system comprising a work machine according to claim 5, wherein the controller outputs an alarm signal when the stress estimated is greater than a predetermined threshold value.

11. A system comprising a work machine, the system comprising:
a work machine body;
a work implement attached to the work machine body;
a plurality of strain sensors arranged along a portion of the work implement that intersects with a virtual plane;
a display device; and
a controller configured to determine a load mode of the work implement based on strain data detected by the plurality of strain sensors, estimate a stress at any location of the work implement, and display, on the display device, when the stress estimated is greater than a predetermined threshold value, a load mode and a portion of the work implement when the stress estimated is greater than the predetermined threshold value.

12. The system comprising a work machine according to claim 1, wherein
each of the plurality of strain sensors comprises a strain gauge and a bridge circuit, and
the strain gauge and the bridge circuit are composed of a semiconductor device.

13. A method for estimating a load state of a work machine comprising a work machine body and a work implement attached to the work machine body, the method comprising:
arranging a plurality of strain sensors along a portion of the work implement that intersects with a virtual plane; and
estimating a load state of the work implement based on strain data detected by the plurality of strain sensors.

14. A method for estimating a load state of a work machine comprising a work machine body and a work implement attached to the work machine body, the method comprising:
arranging a plurality of strain sensors at at least four locations of the work implement; and
estimating a load state of the work implement based on strain data of the at least four locations detected by the plurality of strain sensors.

15. A method for estimating a load state of a work machine comprising a work machine body, a work implement attached to the work machine body, and a display device, the method comprising:
arranging a plurality of strain sensors along a portion of the work implement that intersects with a virtual plane;
determining a load mode of the work implement based on strain data detected by the plurality of strain sensors;
estimating a stress at any location of the work implement; and
displaying, on the display device, when the stress estimated is greater than a predetermined threshold value, a load mode and a portion of the work implement when the stress estimated is greater than the predetermined threshold value.
